(19) United States
(12) Patent Application Publication
(10) Pub. No.: US 2026/0113790 A1
(43) Pub. Date: Apr. 23, 2026

(54) INTELLIGENT PAIRING DECISIONS FOR FIXED WIRELESS ACCESS DEVICES

(71) Applicant: T-MOBILE INNOVATIONS LLC, Overland Park, KS (US)

(72) Inventor: Jasinder Pal SINGH, Olathe, KS (US)

(21) Appl. No.: 18/924,588

(22) Filed: Oct. 23, 2024

(51) Int. Cl. H04W 76/10; H04B 7/0452

(52) U.S. Cl. CPC H04W 76/10; H04B 7/0452

(57) ABSTRACT

Methods, media, and systems are provided for facilitating intelligent pairing decisions in a multi-user (MU) multiple-in-multiple-out (MIMO) system. Device information corresponding to one or more devices served by the fixed wireless access (FWA) device is received from the FWA device. Based on the device information, it is determined whether the FWA device is a candidate for pairing with another device for MU-MIMO. If it is determined that the FWA device is a candidate for pairing, the FWA device is paired with a pairing device, and a set of signals is transmitted using the MU-MIMO to the FWA device and the pairing device. If it is determined that the FWA device is not a candidate for pairing, a set of signals is transmitted to the FWA device without use of the MU-MIMO.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitating intelligent pairing decisions for a Fixed Wireless Access (FWA) device that serves one or more devices, substantially as shown in and/or described in connection with at least one of the figures, and as set forth more completely in the claims.

In aspects set forth herein, and at a high level, the technology described herein relates to facilitating intelligent pairing decisions for an FWA device that serves one or more devices. The intelligent pairing decisions may be based, at least in part, on device information associated with the devices served by the FWA device. In aspects, this information may include a quantity of the one or more devices, or device-specific information. This information may then be communicated to a node that serves the FWA device. This node is responsible for allocating enhanced radio resources, which may include making pairing decisions for beamforming technologies, such as for multi-user (MU) multiple input, multiple output (MIMO) (collectively termed “MU-MIMO”). For instance, instead of the traditional process of blindly making pairing decisions for MU-MIMO (e.g., not basing pairing decisions on anything), the node or another network component may analyze the information from the FWA device and use that to make an intelligent decision. For instance, an FWA device that is serving multiple other devices with a high number of capabilities may be an MU-MIMO pairing candidate, while another FWA device serving no or few other devices may not be an MU-MIMO pairing candidate.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for facilitating resource allocation in a wireless telecommunication network, in accordance with aspects herein;

FIG. 2 illustrates an example flowchart for facilitating intelligent pairing decisions in a MU-MIMO system, in accordance with aspects herein;

FIG. 3 illustrates another example flowchart for facilitating intelligent pairing decisions in a MU-MIMO system, in accordance with aspects herein;

FIG. 4 illustrates another example flowchart for facilitating intelligent pairing decisions in a MU-MIMO system, in accordance with aspects herein; and

FIG. 5 depicts an example computing environment suitable for use in implementations of the present disclosure, in accordance with aspects herein.

### DETAILED DESCRIPTION

MU-MIMO technology allows for the simultaneous transmission of multiple data streams to multiple devices, thereby enhancing the efficiency and capacity of wireless communication networks. However, in some instances, the effectiveness of MU-MIMO largely depends on the optimal pairing of devices that share the communication resources, such as bandwidth and antenna elements.

In scenarios involving FWA devices, which provide broadband internet services to residential or commercial premises, it is becoming increasingly more important to make intelligent decisions about whether these devices should be paired with other devices for MU-MIMO transmission. In present systems, there may not be any procedures in place to make intelligent decisions as to whether an FWA device is to be paired for MU-MIMO. Instead, FWA devices may be blindly paired for purposes of MU-MIMO without consideration of any factors or information. For instance, existing methods for managing MU-MIMO transmissions often lack the intelligence to dynamically assess and pair devices in a way that maximizes the overall network performance. As a result, even if there is an attempt to pair FWA devices based on some sort of information, this leads to FWA devices being either inefficiently paired, leading to suboptimal use of network resources, or unnecessarily excluded from MU-MIMO transmission, thereby missing potential performance gains.

As such, aspects herein provide for methods for facilitating intelligent pairing decisions in a MU-MIMO system, specifically designed to address the challenges associated with FWA devices. The methods involve dynamically assessing the suitability of FWA devices for pairing in a MU-MIMO environment and making real-time decisions that optimize network performance. For instance, a node or other network component receives device information associated with devices served by an FWA device. This device information may comprise device type (e.g., smartphone, laptop), bandwidth usage (e.g., 5 Mbps, 10 Mbps), and latency requirements (e.g., low latency for gaming). This device information is used by the node to make an intelligent pairing decision. The node may determine that the FWA device is to be paired with another device for purposes of signal transmissions, such as MU-MIMO, when, for instance, the FWA device is serving a quantity of device above a threshold, or those devices requires a high throughput or have a high data usage. If, for instance, the FWA device is only serving an IoT device whose data usage is low, such as below a threshold, that FWA device my not be a candidate for MU-MIMO pairing.

The subject matter of aspects herein is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for identifying those elements distinctly that might, for example, otherwise share a same name. Further, the term “some” may refer to “one or more. ” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

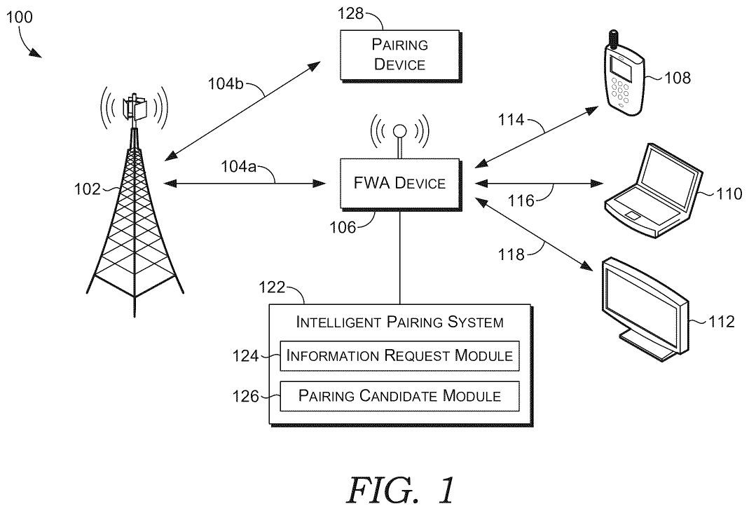

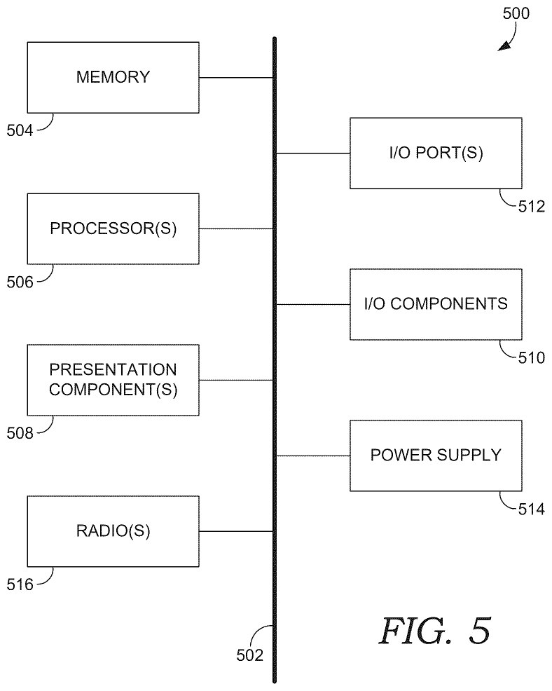

Additionally, a “user device,” as used herein, is a device that has the capability of using a wireless communications network, and may also be referred to as a “computing device,” “mobile device,” “user equipment,” “wireless communication device,” “device,” or “UE. ” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 108, 110, or 112 described herein with respect to FIG. 1. A user device may also be, in another embodiment, similar to user device 500, described herein with respect to FIG. 5.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio—Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Aspects discussed herein may be used with different wireless telecommunication technologies or standards, including, but not limited to, CDMA 1xAdvanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, 6G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, FWA is a type of wireless communication technology that provides broadband internet access to fixed locations, such as homes, offices, and other buildings. Unlike traditional wired broadband services (e.g., DSL, cable, or fiber), FWA uses wireless radio links to connect end-users to the internet. This technology is particularly beneficial in rural or remote areas where laying down wired infrastructure is challenging and costly. The evolution of FWA technology has been driven by advances in wireless communication standards, including 4G LTE and, more recently, 5G. These advancements have significantly improved the bandwidth, latency, and reliability of FWA services, making them a viable alternative to wired broadband in many scenarios. The deployment of FWA has facilitated the bridging of the digital divide by providing high-speed internet access to underserved and unserved regions.

An FWA system primarily comprises two components: the base station (or access point) and the fixed wireless access device (also known as Customer Premises Equipment, or CPE). The base station is a central node that transmits and receives wireless signals to and from multiple FWA devices. It is connected to the core network and the internet backbone. The FWA device is installed at the user's premises. It communicates wirelessly with the base station to provide internet connectivity to the end-user devices, such as computers, smartphones, smart TVs, and other internet-enabled devices within the premises.

The FWA device serves as the intermediary between the user's internal network and the base station. It receives data from the base station and transmits it to the user's devices and vice versa. For optimal performance, FWA devices are usually installed in locations with clear line-of-sight to the base station, such as rooftops or external walls.

FWA devices (e.g., High Speed Internet (HINT) Devices) play a crucial role in the delivery of high-speed internet to fixed locations, especially in areas lacking traditional broadband infrastructure. The continuous exchange of detailed operational data between FWA devices and the base station ensures robust, reliable, and high-performance internet connectivity, thereby enhancing the overall user experience. As FWA technology continues to evolve, the integration of advanced data analytics and AI-driven network management will further optimize the performance and reliability of FWA systems.

Various components may be involved in FWA systems. For exemplary purposes only, some of these components may include a base station that acts as the central hub connected to the internet backbone, and is equipped with antennas to transmit and receive signals over a wide area. The FWA device itself may be installed at the user's premises (home, office, etc.), and it may communicates wirelessly with the base station. Further, the FWA device connects to internal devices through wired (Ethernet) or wireless (Wi-Fi) connections.

The operational workflow for FWA devices includes signal transmission from the base station to the FWA device. The base station emits radio signals that cover a defined service area. These signals carry data to and from the internet. The FWA device, equipped with an antenna, receives these radio signals. Optimal placement of the FWA device is crucial, often requiring line-of-sight to the base station to minimize signal obstruction and interference. The received signals are processed by the FWA device, converting the radio waves into digital data. This involves demodulation, error correction, and data decoding to ensure accurate and efficient data transfer. The processed data is distributed to internal devices (e.g., computers, smartphones, smart TVs) within the user's premises. This distribution can occur via Wi-Fi or Ethernet. For Wi-Fi distribution, the wireless signals within the premises allow mobile and stationary devices to connect without cables. For Ethernet, there are wired connections to devices that support or require stable, high-speed internet access. When a user device requests data (e.g., browsing the internet, streaming video), the FWA device aggregates this data and transmits it back to the base station. The FWA device modulates and encodes the data into radio signals suitable for transmission. The base station receives the data from the FWA device, processes it, and routes it to the appropriate destination on the internet. Responses from the internet are similarly processed and sent back to the FWA device, completing the data exchange cycle.

Modern FWA devices often use advanced antenna technologies, such as Multiple Input Multiple Output (MIMO) and beamforming, to enhance signal strength, range, and reliability. Moreover, FWA devices operate in licensed and unlicensed frequency bands, including sub-6 GHz and millimeter-wave (mmWave) frequencies. The choice of frequency band affects coverage, bandwidth, and penetration capabilities. FWA systems may implement QoS mechanisms to prioritize critical traffic, manage bandwidth allocation, and ensure consistent performance for various applications (e.g., video conferencing, online gaming). Data encryption and secure communication protocols protect user data from interception and unauthorized access. FWA devices can be remotely monitored and updated by service providers, ensuring they run the latest firmware and configuration settings for optimal performance and security.

In an exemplary implementation, consider an FWA device serving a residential area with multiple homes. Each home has several devices connected to the FWA device, such as smartphones, laptops, smart TVs, and IoT devices. The method would proceed as follows: The FWA device determines that there are 10 devices currently connected. It sends requests to these devices, collecting data such as device type (e.g., smartphone, laptop), bandwidth usage (e.g., 5 Mbps, 10 Mbps), and latency requirements (e.g., low latency for gaming). This data is aggregated and communicated to the base station. The base station processes this information and adjusts resource allocation dynamically, ensuring that high-priority devices and applications receive adequate bandwidth and low latency, while less critical applications are managed efficiently.

In conventional MU-MIMO systems, MU-MIMO transmissions often lack the intelligence to dynamically assess and pair devices in a way that maximizes the overall network performance. As a result, there may be instances where FWA devices are either inefficiently paired, leading to suboptimal use of network resources, or unnecessarily excluded from MU-MIMO transmission, thereby missing potential performance gains. Even worse, in many systems, there is no intelligence at all, leading to all FWA device being paired.

There are many advantages to the aspects provided herein, for example enhanced network efficiency. The intelligent pairing decisions help reduce network congestion and improve overall throughput, particularly in dense environments with multiple connected devices. Further, another advantage is improved user experience. By selectively applying MU-MIMO technology, users of both FWA devices and other network devices benefit from more stable and faster connections.

In a first aspect, a method for facilitating intelligent pairing decisions in a MU-MIMO system is provided. The method includes receiving, from an FWA device having a wireless connection with a node, device information corresponding to one or more devices served by the FWA device. Further, based on the device information, the method includes determining whether the FWA device is a candidate for pairing with another device for MU-MIMO. If it is determined that the FWA device is a candidate for pairing, the method includes pairing the FWA device with a pairing device, and transmitting a set of signals using the MU-MIMO to the FWA device and the pairing device. If it is determined that the FWA device is not a candidate for pairing, the method includes transmitting a set of signals to the FWA device without use of the MU-MIMO.

In a second aspect, system is provided for facilitating intelligent pairing decisions in a MU-MIMO system. The system comprises a node having a plurality of antennas, the node being associated with a wireless telecommunication network, and one or more processors communicatively coupled with the node. The system further includes computer memory storing computer-usable instructions that, when executed by the one or more processors, perform operations. The operations comprise receiving, from an FWA device having a wireless connection with a node, device information corresponding to one or more devices served by the FWA device, and based on the device information, determining a downlink transmission profile for a set of signals communicated to the FWA device, the downlink transmission profile indicating whether the FWA device is a candidate for MU-MIMO pairing. Further, the operations comprise transmitting the set of signals to the FWA device based on the downlink transmission profile.

In a third aspect, one or more non-transitory computer storage media having computer-executable instructions embodied thereon is provided, that when executed by at least one processor, cause the at least one processor to perform a method. The method includes receiving, from a FWA device having a wireless connection with a node, device information corresponding to one or more devices served by the FWA device, and based on the device information, allocating enhanced radio resources to the FWA device for transmitting, using MIMO, a set of signals to the FWA device.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for facilitating intelligent pairing decisions for an FWA device within a wireless telecommunications network. The system includes components and interactions between the FWA device and a network node to determine device information for the devices served by the FWA device, such as the number of connected devices, device-specific information. Network environment 100 includes node 102 (e.g., base station), an FWA device 106, a pairing device 128, and user devices 108, 110, and 112.

As mentioned, network environment 100 includes user devices 108, 110, and 112. In network environment 100, user devices 108, 110, and 112 may take on multiple forms, such as cameras, microphones, sensors, googles, and glasses, to name a few, or any other device (such as the computing device (500) that communicates via wireless communications with the FWA device 106 in order to interact with a public or private network.

In some aspects, each of the user devices 108, 110, and 112 may correspond to computing device 500 in FIG. 5. Thus, a user device can include, for example, a display(s), a power source(s) (e.g., a battery), a data store(s), a speaker(s), memory, a buffer(s), a radio(s) and the like. In some implementations, for example, user devices 108, 110, and 112 comprise a wireless or mobile device with which a wireless telecommunication network(s) can be utilized for communication (e.g., voice and/or data communication). In this regard, the user devices 108, 110, and 112 can be any mobile computing device that communicates by way of a wireless network, for example, a 3G, 4G, 5G, 6G, LTE, CDMA, or any other type of network. In some cases, user devices 108, 110, and 112 in network environment 100 can optionally utilize one or more communication channels (not shown) to communicate with other computing devices (e.g., a mobile device(s), a server(s), a personal computer(s), etc.) through the FWA device 106 and node 102. Node 102 may be a gNodeB, eNodeB, or the like.

The network environment 100 may be comprised of a telecommunications network(s) (now shown), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

Communication channels 104a and 104b can be part of a telecommunication network that connects subscribers to their immediate telecommunications service provider (i.e., home network carrier). In some instances, such as when an FWA device is utilized, the communication channels are associated with a telecommunications provider that provides services (e.g., 3G network, 4G network, LTE network, 5G network, 6G network, and the like) to the FWA device, such as the FWA device 106. For example, communication channel 104a may provide voice, SMS, and/or data services to user devices 108, 110, and 112 through the FWA device 106, or corresponding users that are registered or subscribed to utilize the services provided by the telecommunications service provider. Some devices, such as user devices 108, 110, and 112, connect to the FWA device 106 and receive telecommunications services through this device. The communication channels can comprise, for example, a 1× circuit voice, a 3G network (e.g., CDMA, CDMA2000, WCDMA, GSM, UMTS), a 4G network (WiMAX, LTE, HSDPA), or a 5G network or a 6G network.

In some implementations, node 102 is configured to communicate with user devices 108, 110, and 112 by way of the FWA device 106, which may be located in a same area as the user devices 108, 110, and 112. As such, radio antennas of node 102 may send communications to the FWA device 106, which then serves user devices 108, 110, and 112. Node 102 may include one or more base stations, base transmitter stations, radios, antennas, antenna arrays, power amplifiers, transmitters/receivers, digital signal processors, control electronics, GPS equipment, and the like.

The FWA device 106 provides device connectivity to the wireless network to user devices 108, 110, and 112 by way of, for example, communication links 114, 116, and 118. The FWA device 106 serves multiple end-user devices within a specific coverage area, providing broadband wireless connectivity. This device is equipped with components to determine the number of connected devices, request information from them, and communicate with node 102. In some aspects, when there is no traffic served by the FWA device 106, RACH procedure may be used to identify a quantity of user devices connected to the FWA device 106. In the RACH procedure, a user device may send an initial RACH (to access service from the node 102) with a particular nominal power given to the device. In aspects herein, if the FWA device 106 is serving one user device, the FWA Device 106 will use the nominal power given to it. If there are two user devices, the FWA device 106 may send a message with nominal power offset by 1 dbm, for example (e.g., x+1 dbm), and if serving two user devices, the nominal power would be offset with 2 dbm, and so on. This will allow the node 102 to know how many user devices are being served by the FWA device 106, allowing the node 102 to more efficiently plan resources. Once the user devices are connected, the FWA device 106 may request user device capabilities from each connected user device, such as user devices 108, 110, and 112 in FIG. 1. This information is then sent to the node 102, such as by communication channel 104. This device capability information may be communicated to the node 102 in a new message, not currently sent to the node 102 in current aspects, or, the device capability information may be added to an existing message, such as a message sent by the FWA device 106 that includes the device capability information of that FWA device 106. Either way, the capability information may now be sent to the node 102, where previously this information was not sent to or known by the node 102. Knowing this information may help the node 102 to optimize other features of resource allocation by the network.

Integrated within the FWA device or separate from the FWA device is an intelligent pairing system 122. While intelligent pairing system 122 may not be the component allocating resources, it is collecting information and sending this information to the network for to make intelligent pairing decisions.

Intelligent pairing system 122 includes information request module 124, which initiates requests to connected devices to gather specific information. The information requested may include, for exemplary purposed only, device type (e.g., mobile or non-mobile, Internet of Things (IoT) or non-IoT), bandwidth requirements, signal strength, latency sensitivity, beamforming capability (e.g., MIMO), supported features on the device, new radio (NR) capability, throughput maximum, carrier aggregation capability, and current usage patterns. Information request module 124 ensures the FWA device 106 collects comprehensive data necessary for resource allocation. Information request module 124 may also determine a quantity of devices served by the FWA device, which may be used to make pairing decisions.

Intelligent pairing system 122 also includes pairing candidate module 126. Also part of the FWA device 106 or some other device, this module is responsible for analyzing the device information received from the FWA device and intelligently determining whether the FWA device is a good candidate for pairing. In one aspect, if the FWA device serves a quantity of devices above a threshold, that FWA device may be a candidate for pairing. In another aspect, if the devices served by the FWA device have a combined or even individual data usage above a threshold, that FWA device may be a candidate for pairing. Any device information that the FWA device receives and communicates to the node can be used to make intelligent pairing decisions.

If it is determined that the FWA device 106 is to be paired, the pairing device 128 and the FWA device 106 may be served by multiple antennas simultaneously. In In traditional MIMO (often referred to as SU-MIMO or Single User MIMO), a wireless router can send multiple data streams to a single device at a time. But with MU-MIMO, the router can send multiple data streams to multiple devices at the same time. For example, in a 4×4 MU-MIMO router, four devices can each receive a separate data stream simultaneously. MU-MIMO often uses beamforming technology to direct wireless signals specifically towards each device, rather than broadcasting the signal in all directions. This focused transmission helps reduce interference and increases the efficiency of the data transfer. Because multiple devices are served simultaneously rather than sequentially, network latency is reduced, and overall throughput (total data transmitted in the network) is increased. This is particularly beneficial in environments with many connected devices, such as homes with multiple smartphones, tablets, smart TVs, and IoT devices. The process for selecting the pairing device 128 as the device to be paired with the FWA device 106 may considered one or many factors. In some aspects, the router dynamically groups devices based on their bandwidth needs and signal quality. Devices with similar requirements are grouped together so that they can be served simultaneously.

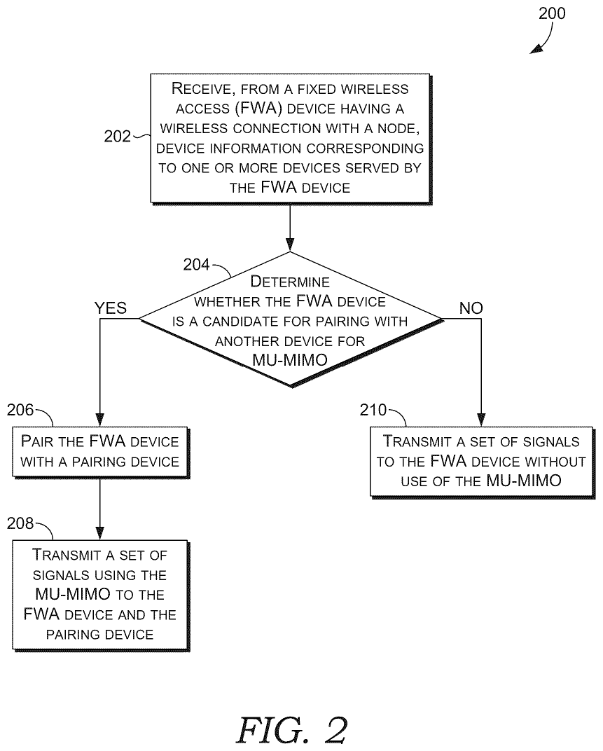

FIG. 2 illustrates an example flowchart of a method 200 for facilitating intelligent pairing decisions for an FWA device serving one or more devices, in accordance with aspects herein. At block 202, device information corresponding to one or more devices served by the FWA device is received from the FWA device. Device information may refer to a device type, such as an Internet of Things (IoT) device, which may require less or different resources than a non-IoT device, and thus may not always put the FWA device in a position to be a candidate for pairing. Device information may also include device capability information, which comprises at least one of a quantity of component carriers that can be aggregated, a maximum throughput, multiple-in-multiple-out (MIMO) capabilities, data usage by the one or more devices, or supported features. At block 204, it is determined whether the FWA device is a candidate for pairing with another device for MU-MIMO based on the device information. If it is a candidate, at block 206, the FWA device is paired with a pairing device. At block 208, a set of signals is transmitted to the FWA device using MU-MIMO technology. In one aspect, it may be determined that the FWA device is a candidate for pairing if the device information indicates that a current time of day historically corresponds to a data usage by the one or more devices served by the FWA device that is above a threshold. As mentioned herein, the device paired with the FWA device (“pairing device”) may be selected based on one or more factors, such as the device information associated with the devices served by the FWA device. For example, the pairing device and the FWA device both may have similar data usage requirements, which, in one aspect, are above a threshold. Here, the data usage corresponding to the FWA device and the pairing device may be within a predetermined threshold of each other. Similarly, another network resource requirement may be similar between the pairing device and the FWA device. In some aspects, the pairing device may be another FWA device. If it is not a candidate based on the device information, at block 210, a set of signals is transmitted to the FWA device without use of pairing/MU-MIMO.

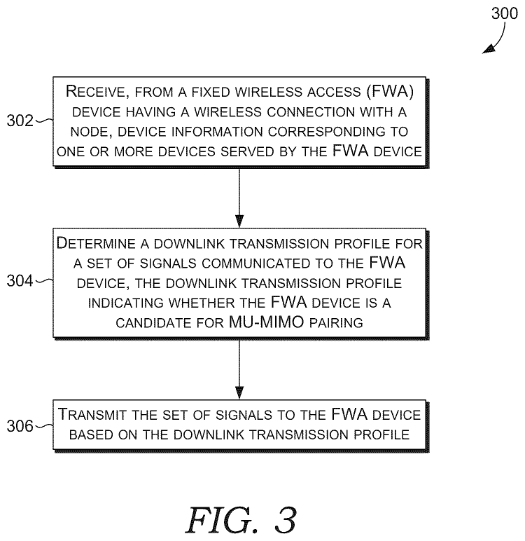

Turning now to FIG. 3, FIG. 3 illustrates another example flowchart of a method 300 for facilitating intelligent pairing decisions for an FWA device serving one or more devices, in accordance with aspects herein. At block 302, device information is received from the FWA device corresponding to the devices served by the FWA device. In aspects, the device information comprises at least one of a quantity of component carriers that can be aggregated, a maximum throughput, multiple-in-multiple-out (MIMO) capabilities, data usage requirements, or supported features. Device information may also comprise a device type, such as whether the device is an IoT device or a non-IoT device. At block 304, a downlink transmission profile is determined for a set of signals communicated to the FWA device. The downlink transmission profile may indicate whether the FWA device is a candidate for the MU-MIMO pairing. At block 306, the set of signals is transmitted to the FWA device based on the downlink transmissions profile. If the FWA device is paired with a pairing device, the communication from the antennas of the node to both devices may be simultaneous (e.g., MU-MIMO).

In the event the FWA device is a candidate for pairing, such as if the downlink transmission profile indicates a pairing of the FWA device with a pairing device, the device information may have indicated, for example, that the data usage corresponding to the devices served by the FWA device is above a threshold, such as what may be termed a high data usage. In aspects, the pairing device may be selected based on the device information from the FWA device. For example, in aspects, the data usage corresponding to the devices served by the FWA device and the pairing device may be within a predetermined threshold, meaning that their data usages are similar.

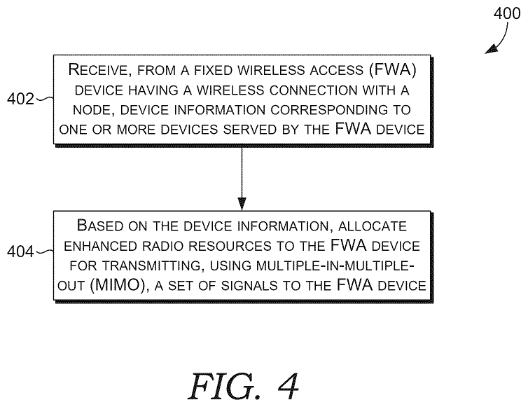

FIG. 4 illustrates another example flowchart of a method 400 for facilitating intelligent pairing decisions for an FWA device serving one or more devices, in accordance with aspects herein. At block 402, device information associated with the devices served by the FWA device is received from the FWA device. The device information may comprise device type and device capability information for the devices served by the FWA device. Device capability information may comprise, for instance, at least one of a quantity of component carriers that can be aggregated, a maximum throughput, MIMO capabilities, or supported features. Device type may include, for instance, whether a device is an IoT device or a non-IoT device. In other aspects, device type could be smartphones and tablets, laptops and desktop computers, smart televisions and streaming devices, smart home devices, gaming consoles, wearable devices, printers and scanners, all types of IoT devices (e.g., Internet-connected sensors, appliances, and other gadgets used for various purposes like home automation, health monitoring, and industrial applications), VoIP phones, Virtual Reality (VR) and Augmented Reality (AR) Devices, network storage devices, connected vehicles, smart appliances, medical devices, industrial and commercial equipment, and the like.

At block 404, based on the device information, enhanced radio resources are allocated to the FWA device, the enhanced radio resources comprising whether the FWA device is to be paired with another device for MU-MIMO. The enhanced radio resources may also comprise time slots, frequency channels, or power levels.

Having described the example embodiments discussed above of the presently disclosed technology, an example operating environment of an example user device (e.g., user device 102A of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 508 can present a visualization that compares a plurality of inspections of one or more cores of a central processing unit and a visualization of each task of each of the plurality of inspections.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof. The one or more radios 516 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A method for facilitating intelligent pairing decisions in a multi-user (MU) multiple-in-multiple-out (MIMO) system, the method comprising:
receiving, from a fixed wireless access (FWA) device having a wireless connection with a node, device information corresponding to one or more devices served by the FWA device;
based on the device information, determining whether the FWA device is a candidate for pairing with another device for MU-MIMO;
if it is determined that the FWA device is a candidate for pairing,
(1) pairing the FWA device with a pairing device, and
(2) transmitting a set of signals using the MU-MIMO to the FWA device and the pairing device; and
if it is determined that the FWA device is not a candidate for pairing, transmitting a set of signals to the FWA device without use of the MU-MIMO.

2. The method according to claim 1, wherein the device information comprises a quantity of the one or more devices served by the FWA device.

3. The method according to claim 1, wherein it is determined that the FWA device is a candidate for pairing if the device information indicates that data usage corresponding to the one or more devices served by the FWA device is above a threshold.

4. The method according to claim 1, wherein it is determined that the FWA device is a candidate for pairing if the device information indicates that a current time of day historically corresponds to a data usage by the one or more devices served by the FWA device being above a threshold.

5. The method according to claim 1, further comprising selecting the pairing device based on the device information corresponding to the one or more devices served by the FWA device.

6. The method according to claim 1, wherein a data usage corresponding to the one or more devices served by the FWA device and the pairing device are within a predetermined threshold of each other.

7. The method according to claim 1, wherein the device information comprises at least one of a quantity of component carriers that can be aggregated, a maximum throughput, capabilities, or supported features.

8. The method according to claim 1, wherein the pairing device is an FWA device.

9. A system for facilitating intelligent pairing decisions in a multi-user (MU) multiple-in-multiple-out (MIMO) system, the system comprising:
a node having a plurality of antennas, the node being associated with a wireless telecommunication network;
one or more processors communicatively coupled with the node; and
computer memory storing computer-usable instructions that, when executed by the one or more processors, perform operations comprising:
receiving, from a fixed wireless access (FWA) device having a wireless connection with a node, device information corresponding to one or more devices served by the FWA device;
based on the device information, determining a downlink transmission profile for a set of signals communicated to the FWA device, the downlink transmission profile indicating whether the FWA device is a candidate for MU-MIMO pairing; and
transmitting the set of signals to the FWA device based on the downlink transmission profile.

10. The system of claim 9, wherein it is determined that the FWA device is a candidate for MU-MIMO pairing if the device information indicates that data usage corresponding to the one or more devices served by the FWA device is above a threshold.

11. The system according to claim 9, wherein the downlink transmission profile indicates a pairing of the FWA device with a pairing device.

12. The system according to claim 9, further comprising selecting the pairing device based on the device information corresponding to the one or more devices served by the FWA device.

13. The system according to claim 9, wherein a data usage corresponding to the one or more devices served by the FWA device and the pairing device are within a predetermined threshold of each other.

14. The system according to claim 9, wherein the device information comprises at least one of: a quantity of component carriers that can be aggregated, a maximum throughput, multiple-in-multiple-out (MIMO) capabilities, or supported features.

15. The system according to claim 9, wherein the device information comprises a device type, the device type comprising an Internet of things (IoT) device or a non-IoT device.

16. One or more non-transitory computer storage media having computer-executable instructions embodied thereon, that when executed by at least one processor, cause the at least one processor to perform a method comprising:
receiving, from a fixed wireless access (FWA) device having a wireless connection with a node, device information corresponding to one or more devices served by the FWA device; and
based on the device information, allocating enhanced radio resources to the FWA device for transmitting, using multiple-in-multiple-out (MIMO), a set of signals to the FWA device.

17. The one or more non-transitory computer storage media of claim 16, wherein the device capability information comprises at least one of a quantity of component carriers that can be aggregated, a maximum throughput, multiple-in-multiple-out (MIMO) capabilities, or supported features.

18. The one or more non-transitory computer storage media of claim 16, wherein the enhanced radio resources comprise at least one of time slots, frequency channels, or power levels.

19. The one or more non-transitory computer storage media of claim 16, wherein the enhanced radio resources comprise at least one of special resource allocation, power allocation, bandwidth allocation, user groupings for the MU-MIMO, adaptive beamforming, dynamic spectrum allocation, interference management, or network slicing.

20. The one or more non-transitory computer storage media of claim 16, wherein the allocating the enhanced radio resources comprises pairing the FWA device with a pairing device, the pairing device being selected based on the device information corresponding to the one or more devices served by the FWA device.
